(19) United States
(12) Patent Application Publication
(10) Pub. No.: US 2021/0218568 A1
(43) Pub. Date: Jul. 15, 2021

(54) Method and System for Protecting Passwords Offline

(71) Applicant: JOSE ALFREDO HERNANDEZ, BELL, CA (US)

(72) Inventor: JOSE ALFREDO HERNANDEZ, BELL, CA (US)

(21) Appl. No.: 16/744,038

(22) Filed: Jan. 15, 2020

(51) Int. Cl. H04L 9/08; G06F 21/31; C09D 11/50; H04L 9/32

(52) U.S. Cl. CPC H04L 9/0894; G06F 21/31; C09D 11/50; G06F 2221/2115; G06F 2221/2113; H04L 2209/16; H04L 9/3226

(57) ABSTRACT

A method and system for protecting passwords offline is disclosed. The invention being comprised of a notebook made from pages having grains of crushed calcium carbonate stone and a combo cipher marker and UV torch. The notebook contains tables and matrices to accommodate the ciphering process, a marker that contains transparent ink to hide passwords and a UV torch to exposes hidden passwords. The passwords themselves are encrypted by means of a process involving character mapping and key codes recorded into the notebook with the combo cipher marker and UV torch. These encrypted passwords remain invisible until the user shines the pages with the UV torch on the cap and passwords can then be retrieved and unscrambled. An object of the invention is to enhance password security by archiving them completely offline and off any electronic networks.

### FIELD OF THE INVENTION

The present invention generally relates to the field of security. More specifically, it relates to a manual cipher for protecting computer passwords.

### BACKGROUND

The earliest encryption is known to have occurred around 600 BCE when Spartans used a device called a ‘scytale’ to send secret messages during battles. The scytale consisted of a leather strap wrapped around a wooden rod. Letters along the strap could be interpreted as it was unwound from the rod. Julius Caesar was known to have developed his own form of ciphers that shifted characters by three places in the alphabet. Centuries later in the 1800s, Charles Wheatstone invented the ‘Playfair Cipher’ that encrypted pairs of letters instead of single ones and was difficult to decipher. In the early 1900s Edward Hebern invented an electro-mechanical machine in which the key was embedded in a rotating disc and German engineer invented the Enigma machine and the military used it to send coded transmissions. In the 1970s IBM formed a ‘crypto group’ which designed a block cipher to protect the customer data and was adopted as a national standard called the Data Encryption Standard. Today there are a wide range of electronic encryption services and block chain software is becoming increasingly popular. As more security is needed in the modern era cryptographers are constantly developing and refining solutions to this challenge—particularly in regards to password protections. U.S. Pat. No. 8,347,103B2 granted to Jones and Sherry disclosed a method of ciphering passwords based on pictograms; however, it does not incorporate a manual method. U.S. Pat. Nos. 7,243,239B2 and 5,559,961A granted to Microsoft and Blonder respectively disclosed a password protection systems using tile selections and graphical imagery but they do not incorporate a means for manual ciphering. Another popular password protection method is provided through a company called LastPass; however it does not store passwords offline. What is needed is a discreet method for the safe storage of passwords offline using a manual method.

### SUMMARY OF THE INVENTION

The device herein disclosed and described provides a solution to the shortcomings in the prior art through the disclosure of a manual method of protecting passwords using a notebook with transparent ink pen and a UV torch. An object of the invention is to allow users to secure a password log that is not part of any electronic network.

Another object of the invention is to provide a means to allow users to encrypt passwords using a specific formula based on character mapping passwords with key codes within tables in the notebook. This notebook also has pages made from environmentally friendly crushed stone grains that make it water resistant and durable.

Another object of this invention is to provide a means to record passwords and encrypted passwords using a dedicated pen with transparent ink. Should the notebook fall into the wrong hands passwords will not appear.

Another object of the aforementioned invention is to allow only the user to decrypt the passwords. When reading passwords the user will activate the pen that shines an ultraviolet light at the page revealing the transparent ink and rending the writing legible.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention.

FIG. 2 shows a perspective view of the invention revealing hidden text.

FIG. 3 shows a plan view of the identification section.

FIG. 4 shows a plan view of the private key section.

FIG. 5 shows a plan view of the shieldcrypt section. section.

FIG. 6 shows a plan view of the recovery phrase section.

FIG. 7 shows a plan view of the recovery phase section.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the invention as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

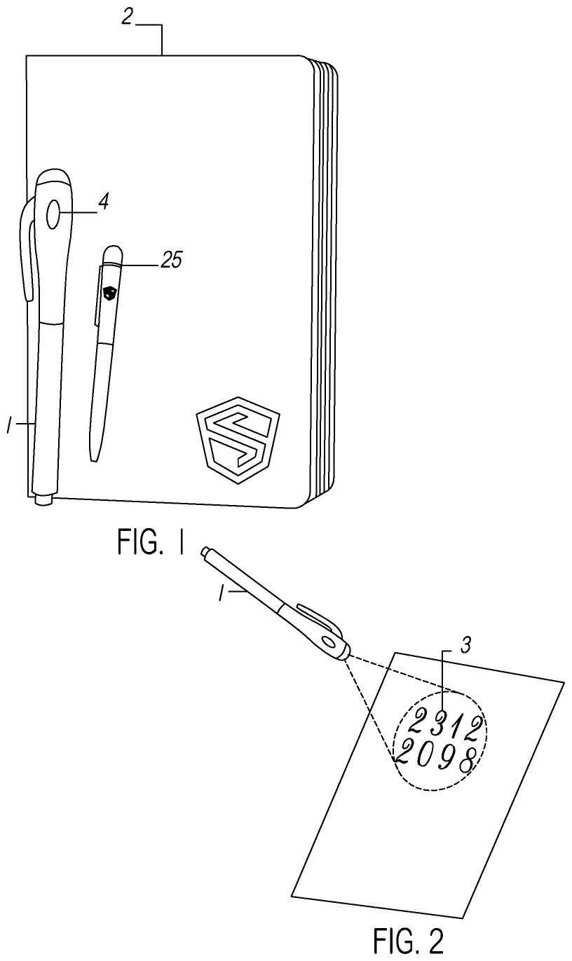

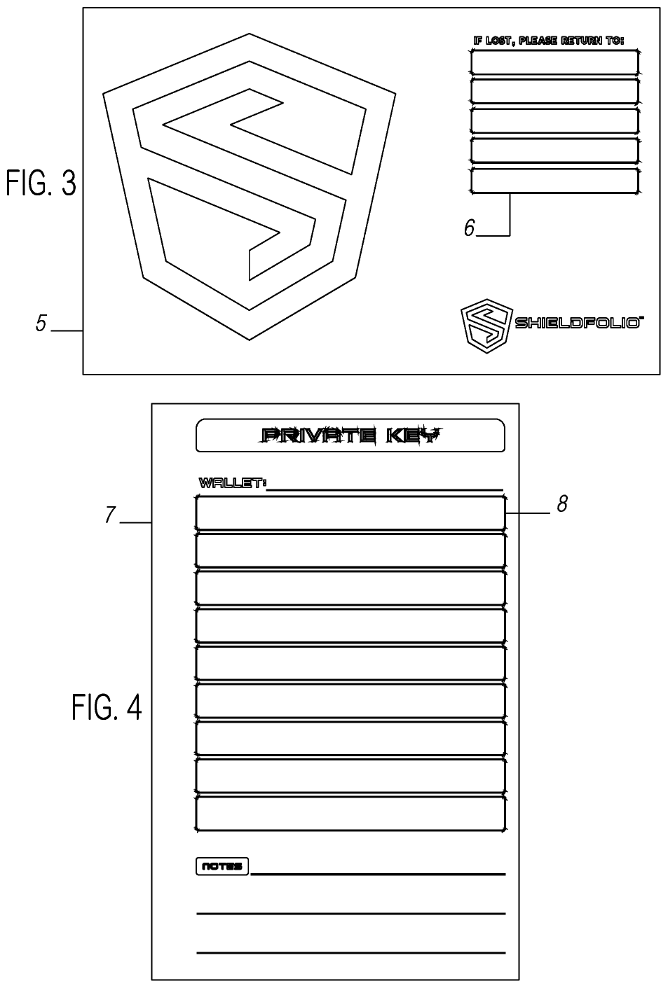

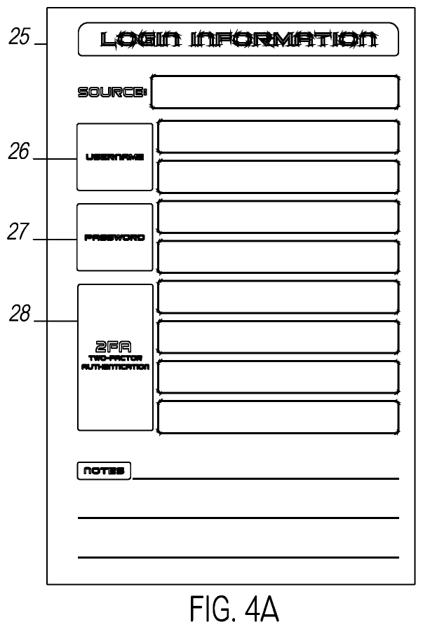

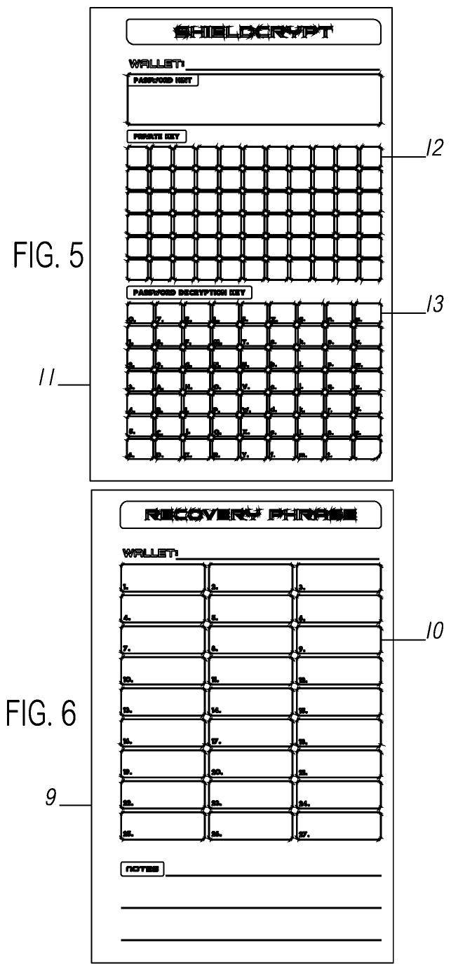

FIG. 1 shows a perspective view of the invention being comprised of combo cipher marker and UV torch 1 with activation button 4 and notebook 2. Pages in said notebook 2 made of but are not limited to grains of crushed stone, paper (comprised of calcium carbonate and trace amounts of plastic as a binder) and the like. FIG. 2 shows a perspective view of combo cipher marker and UV torch 1 dispensing transparent ink during writing and creating hidden text 3. The figure also revealing hidden text 3 by means of UV light illuminated by said activation button 4. FIG. 3 shows a plan view of the identification section 5 of notebook 2 allowing a user to record personal information such as but not limited to their name, address, telephone number, electronic mail address etc. FIG. 4 shows a plan view of the private key section 7 allowing a user to enter their private passcodes with said combo cipher marker and UV torch 1. FIG. 4A shows a login information section 25 having elements including but not limited to a username, password and two-factor authentication. FIG. 5 shows a plan view of the shieldcrypt section 11 wherein users encrypt their passcodes and includes places to record features such as but not limited to password hints, private keys 12, and password decryption key 13. FIG. 6 shows a plan view of the recovery phrase section.

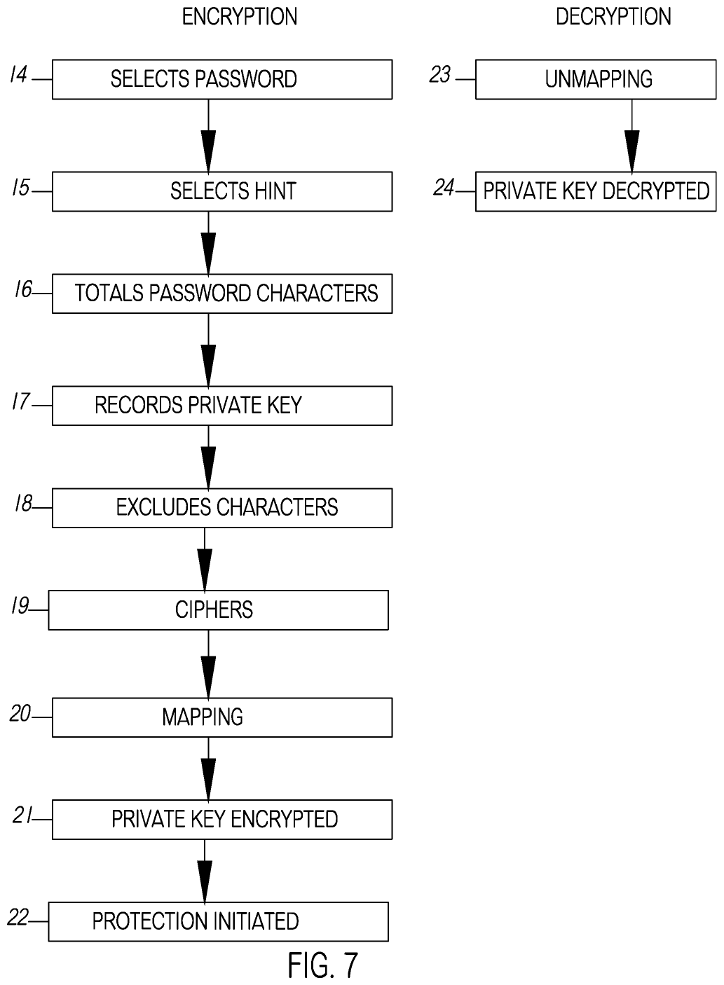

FIG. 7 shows a flow diagram of the invention process. Steps of this method include but are not limited to During encryption, user selects a password and writes it down on a worksheet in step 14. User writes password hint inside password hint section 12a on shieldcrypt form 11 in step 15. User totals actual characters in password in step 16. User inserts characters of private key (from bitcoin, etherium etc.) into private key section in step 17. While inserting the private key, the user excludes the number of boxes that represent the total number of characters in the password randomly in the private key section 12 and leaves these boxes empty in step 18. In step 19 user writes each excluded character under each character of the password on the worksheet—these are called ciphers. In step 20 user writes each cipher character into the corresponding password decryption key section 13 boxes that have the corresponding password characters already listed inside the boxes using a regular pen—this is called mapping. User fills in all empty boxes in the password decryption key section 13 with random characters. Password is now encrypted in step 21 and protection is initiated in step 22. During decryption, user decrypts the private key section using the private key section 12. User identifies each box in the private key section 12 that has the corresponding password character already listed inside the boxes of the password decryption key section 13 and transfers the written characters into the empty private key section 12 boxes.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1.) A system for protecting passwords away from electronic networks comprised of the following parts:
a) a cipher marker to hide passwords;
b) a UV torch; to reveal hidden passwords; and
b) a notebook.

2.) The system for protecting passwords away from electronic networks of claim 1 wherein the notebook having a login information section, a personal information section, a private key section, a shieldcrypt section and a recovery phrase section.

3.) The system for protecting passwords away from electronic networks of claim 1 wherein the notebook having pages made of grains of calcium carbonate stone and trace amounts of plastic as a binder

4.) A method for protecting passwords away from electronic networks, the method comprised of the following steps:
a) selecting a password;
b) creating a hint;
c) totaling password characters;
d) inserting a private key;
e) generating a cipher;
f) mapping private keys;
g) filling in empty boxes;
h) unmapping and
i) shining a UV light.

5.) The method for protecting passwords away from electronic networks of claim 4 wherein selecting a password includes the step of a selecting at least 15 alphanumeric characters with no repeating characters.

6.) The method for protecting passwords away from electronic networks of claim 4 wherein creating a hint includes the step of relating the hint to the password selected.

7.) The method for protecting passwords away from electronic networks of claim 4 wherein inserting a private key includes the step of excluding a number of boxes randomly that total the same number of characters in the password.

8.) The method for protecting passwords away from electronic networks of claim 4 wherein mapping includes the step of writing each cipher character into the corresponding password decryption key boxes that have the corresponding password characters already listed inside the boxes.

9.) The method for protecting passwords away from electronic networks of claim 4 wherein unmapping includes the step of decrypting whereby a user identifies each box in the private key that has the corresponding password character already listed inside the boxes of the password decryption key and transfers the written characters into the empty private key boxes.

10.) The method for protecting passwords away from electronic networks of claim 4 wherein shining a UV light includes the step of directing the UV light at a hidden password to allow a user to read it.
